(19) United States
(12) Patent Application Publication
(10) Pub. No.: US 2018/0085974 A1
(43) Pub. Date: Mar. 29, 2018

(54) AUTO CLEAN SURFACE AND METHOD OF MAKING SAME

(71) Applicant: Palram Industries (1990) Ltd., Kibbutz Ramat Yohanan (IL)

(72) Inventor: Reuven HUGI, Nahariya (IL)

(73) Assignee: Palram Industries (1990) Ltd., Kibbutz Ramat Yohanan (IL)

(21) Appl. No.: 15/559,471

(22) PCT Filed: Mar. 17, 2016
(86) PCT No.: PCT/IL2016/050295

§ 371 Date: Sep. 19, 2017

Related U.S. Application Data
(60) Provisional application No. 62/135,205, filed on Mar. 19, 2015.

(51) Int. Cl. B29C 44/06; B08B 17/06; B29C 47/00; B29C 47/06

(52) U.S. Cl. CPC B29C 44/06; B08B 17/065; B29C 2035/0827; B29C 47/065; B29C 47/0021

(57) ABSTRACT

A supper hydrophobic surface (e.g., autoclean surface) and methods of making such a surface. The method includes forming an open porosity on a surface of a product, the open porosity including pores having undercuts and attaching functional nano-particles to the surface, such that the functional nano-particles are located inside the open porosity. The open porosity is formed by various methods such as, for example, co-extruding or applying a polymeric material with a blowing agent and/or etching the surface and/or directly printing a porous layer on the surface.

### BACKGROUND OF THE INVENTION

Self-clean or auto-clean surfaces that rely on hydrophobic or super-hydrophobic properties are known both in nature (e.g., a lotus leave) and as a product made by men. The artificial auto-clean surfaces are usually made by introducing a controlled roughness to the surface and coating the surface with a coating comprising hydrophobic nanoparticles. The hydrophobic nanoparticles are attached to the surface using covalent bonds thus may be torn out from the surface under abrasive forces, therefore, reducing the hydrophobic property of the surface.

### SUMMARY

Embodiments of the invention may be related to supper hydrophobic surfaces (e.g., auto-clean surfaces) and methods of making such surfaces. A method according to some embodiments of the invention may include forming an open porosity on a surface of a product, the open porosity may include pores having undercuts and attaching functional nano-particles to the surface, such that the functional nano-particles may be located inside the open porosity. The open porosity may be formed by various methods such as, for example, co-extruding or applying a polymeric material with a blowing agent and/or etching the surface and/or directly printing a porous layer on the surface.

Another method according to some embodiments of the invention may include printing a first layer on the surface of the product including a first material and printing a second layer on the first layer including a second material. In this method the first and second materials may have a surface tension lower than 30 [Dyn/cm] and a wetting angle higher than 100°, thus may form defined rounded droplets of the surface, for forming a supper hydrophobic surface.

A supper hydrophobic surface according to embodiments of the invention may have a sliding angle (of the water droplets sliding on the surface) of less than 15° and contact angle larger than 100° or even larger than 115°.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart of a method of forming a super hydrophobic surface on a product according to some embodiments of the invention;

FIG. 2 is an illustration of an exemplary porous surface according to some embodiments of the invention;

FIG. 3 is an illustration of an exemplary porous surfaces on a product in process according to some embodiments of the invention;

FIG. 4 is an illustration of an exemplary porous surfaces on a product in process according to some embodiments of the invention;

FIG. 5 is an illustration of an exemplary functional nano-element inside a pore according to some embodiments of the invention;

FIG. 6 is an exemplary treated fumed nano-silica particle according to some embodiments of the invention;

FIG. 7 is a flowchart of a method of forming a super hydrophobic surface on a product according to some embodiments of the invention; and

FIG. 8 is an illustration of an exemplary printed surface according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the invention may relate to various methods of forming auto-clean (e.g., hydrophobic or supper hydrophobic) surfaces on a product, for example, a board or a panel. The product may be rigid or may be flexible. The product may include mainly a polymer or may be coated by a polymer. The auto-clean surface may reject liquid droplets (e.g., rain) and dust.

Reference is made to FIG. 1, which is a flowchart of a method of forming an auto-clean surface on a product according to some embodiments of the invention. In box 110, some embodiments may include, forming an open porosity on the surface of the product; the open porosity may include pores having undercuts.

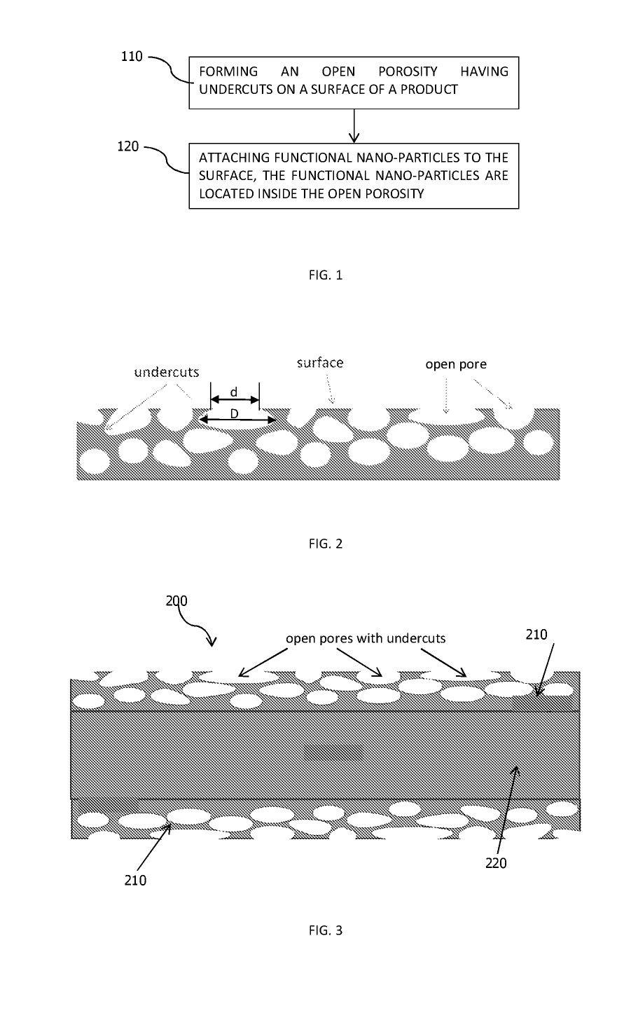

The open porosity may be formed by any method known in the art of forming on a polymeric surface an open porosity having undercuts. As used herein, undercuts are defined as open holes or open pores having a recess such that a dimension d of the opening (to the surface) of the recess is smaller than a dimension D (below the surface) of the recess, as illustrated in FIG. 2. An exemplary open porosity may have a dimension D between 0.5 micron and 2 mm. In some embodiments, the distances between pores may be between 10-30 microns. Some exemplary methods of forming porosity on a surface of an object are given below.

In some embodiments, forming an open porosity may include mixing a blowing agent with a polymeric component and extruding the polymeric mixture. During the extrusion the blowing agent may expend to form porosity in the extruded product. The product formed by this method may include porosity trapped in the entire volume of the product, as illustrated in FIG. 2. The blowing agent may include a chemical blowing agent (CBAs) such as Azodicarbonamide, Sodium bicarbonate or the like. CBAs rely on releasing of gas during decomposition at elevated temperatures and pressure, for example, during extrusion. Additionally or alternatively, the blowing agents may include physical blowing agents (PBAs) such as Hydrocarbons, HCFCs, N2 or CO2 gases or the like, that react to a change of a state, for example, under high pressure at elevated temperature. The size of the pores may be controlled by the type and amount of blowing agent added into the polymeric mixture.

The mixture comprising the polymeric component (e.g., a Polycarbonate or Polyvinylchloride (PVC)) and the blowing agent may be extruded, using any known method, to form the product (e.g., a board or a panel). During the extrusion, the blowing agent may extend and/or explode inside the polymeric component due to the high temperatures and pressure employed by the extruder, forming porosity in the entire volume of the product. The porosity formed near the surface of the product may open (i.e., at partially reviled or exposed) during the extrusion, forming a porous surface having open porosity with undercuts, as illustrated in FIG. 2. In some embodiments, the porosity formed near the surface of the product may include mainly closed porosity (e.g. porosity entrapped or entirely contained within the product), and an additional etching may be required to open the porosity, for example, etching polycarbonate or PVC may be done using sodium hydroxide. In some embodiments, an additional mechanical surface treatments such as, polishing or grinding, may be applied to the coated surface to open the close porosity.

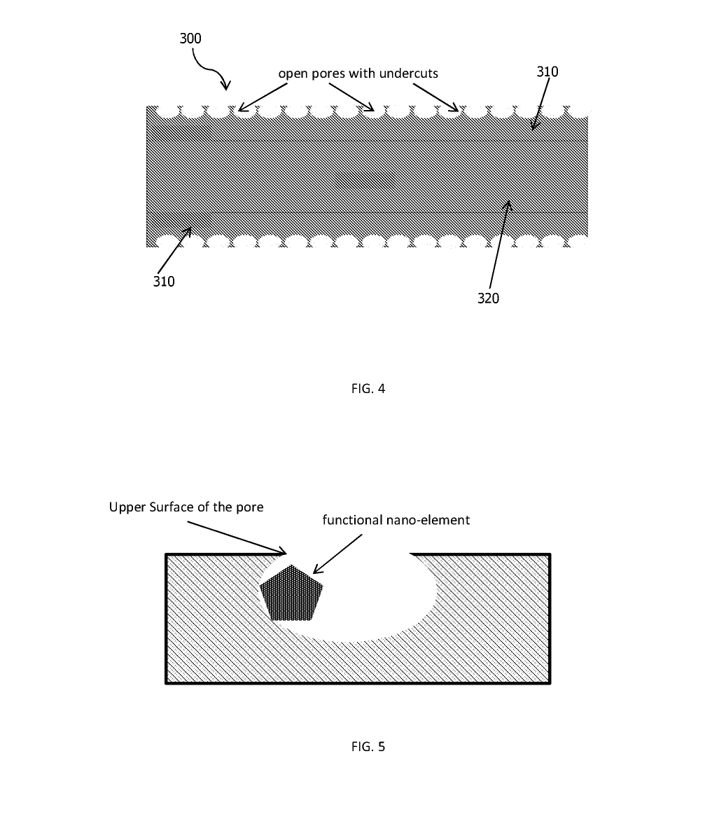

In some embodiments, forming porous surface having an open porosity may include extruding a base product (e.g., a base panel or a base board). That may not include any substantial porosity. At least one pours layer may be co-extruded on the surface of the based product. Reference is made to FIG. 3 that is an illustration of a product in process according to some embodiments of the invention. A product in process 200 may include two porous layers 210 and a base product 220 comprising a first polymeric component. Based product 220 may be extruded from the first polymeric component (e.g., a polycarbonate or PVC) using any known method.

Following the extrusion of base product 220, the method may further include mixing a blowing agent in a second polymeric mixture. The blowing agent may be the CBA and/or the PBA disclosed above. The second polymeric component may be the same as the first polymeric component (e.g., a polycarbonate or PVC) or may be a different polymeric component. The mixture of the second polymeric component and the blowing agent may be co-extruded as an additional layer on the base product to form the product in process, as shown in FIG. 3.

In some embodiments, the porous layers may form open porosity during the co-extrusion process. In some embodiments, the co-extrusion process may form a close porosity and etching and/or mechanical surface treatments may be required in order to open the porosity formed close to the surface of the co-extruded product.

In some embodiments, the method may include etching the surface of a product in process with a porosity forming etching solution to form the porous surface. Reference is made to FIG. 4 which is an illustration of a product in process according to some embodiments of the invention. The open porosity may be formed using any suitable etching solution known in the art. A product 300, may include a base extrude product 320 and one or more etched porous layers 310, etched on one or more surfaces of based extrude product 320. For example, Polycarbonate based product may be etched with sodium hydroxide and acetic acid at room temperature or at an elevated temperature for a relatively short time (e.g., few seconds to several minutes). The cells (e.g., pores) structure formed by this method may be relatively finer and denser in comparison to the cells structure formed using PBA or CBA having usually less undercuts as illustratively shown in FIG. 4.

In some embodiments, forming the open porosity may include coating the object with a porous coating. The coating may include a polymeric component that may be mixed with blowing agents or may include any other polymeric coating configured to form open porosity having undercuts on the surface of the product. An exemplary such polymeric coating may include a polycarbonate or PVC having silica particles (e.g., fumed silica nano-particles) embedded in the coating.

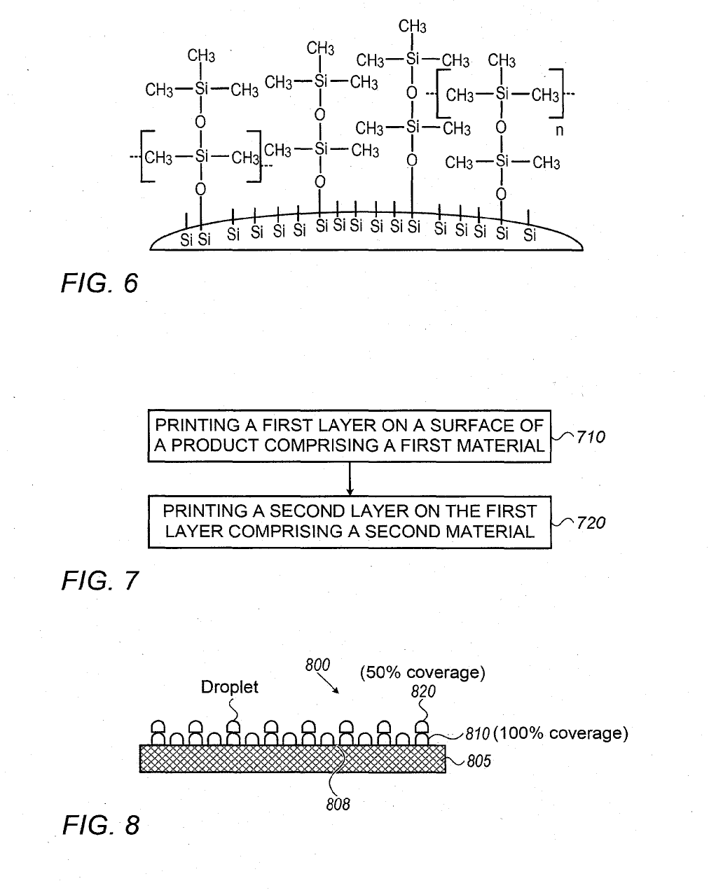

In some embodiments, forming the open porosity may include printing (e.g., using an inkjet printer) a plurality of layers each comprising a material having a surface tension lower than 30 Dyn/cm and a wetting angle higher than 100°, as disclosed below with respect to the method of FIG. 6.

Refereeing back to FIG. 1, in box 120 some embodiments may include attaching functional nano-particles to the surface, such that the functional nano-particles are located inside the open porosity. Each functional nano-element (e.g., nano-particle) may be trapped in the undercut space of the pore. In some embodiments, the functional nano-elements are located in the pores such that the elements do not substantially exceed above the surface of the extruded panel/board. FIG. 5 is an illustration of a functional nano-particle trapped inside a pore below the level of the upper surface of the pore according to embodiments of the invention. Functional nano-elements located inside the open porosity, according to some embodiments of the invention may not easily be torn apart from the surface, thus allowing the surface to maintain the auto-clean property even after being exposed to abrasion forces. The functional nano-particles may have a dimension smaller than 1 micron, smaller than 500 nanometers (nm), smaller than 250 nm or smaller.

In some embodiments, the functional nano elements may include functional nano-particles such as: silicon, silicates, polysiloxane, fluorinated compounds or the like. The nano-elements may include low surface energy groups, as illustrated in FIG. 6. FIG. 6 is a chemical representation of treated fumed silica nano-particle with low surface energy groups, according to some embodiments of the invention. In some embodiments, the functional nano-elements may include functional particles, for example, oxide particles: metal oxide particles such as aluminum oxide, siliciumoxide, zirconium oxide, titanium oxide, antimony oxide, zinc oxide, tin oxide, indium oxide, cerium oxide, or the like. In some embodiments, the functional nano-elements may include functional molecules, for example, carbon nanotubes, Polyhedral oligomeric silsesquioxane (POSS), poly(tetrafluoroethene) (FTFE), or the like.

The functional nano-elements may be attached to the porous surface to form hydrophobic surface (i.e., wetting angle θ>90°) or even supper hydrophobic surface (i.e., wetting angle θ>150°). In order to enhance the hydrophobic property of the particles, low surface energy groups may be attached to each particle (as illustrated in FIG. 6). For example, silanizing agents may be employed to introduce R4-nSi—. Suitable silanizing agents may have both leaving groups and terminal functionalities. Terminal functionalities are groups that are not displaced by reaction of a silanizing agent with silica second particles (e.g., R groups of compounds of the formula (I)). Leaving groups are those groups that are displaced from silanizing agents upon reaction to form bonds with nanoparticles.

In some embodiments, attaching the functional nano-elements to the porous surface may include spraying an emulsion including the functional nano-elements on top of the surface. For example, such an emulsion may include the functional nano-elements, an adhesion promoter and a solvent for dilution. After spraying the functional nano-elements may be attached to the pores by Van-Der-Waals forces per se. Additionally or alternatively, ultraviolet radiation may be applied to the surface to increase the bonding between the functional nano-elements and the surface of the pore.

In some embodiments, attaching the functional nano-elements to the porous surface may include gluing the functional nano-elements to the surface. The nano-elements may be sprayed using an emulsion, may be smeared on the porous surface, or the like. In some embodiments, attaching the functional nano-elements may include coating the surface with a coating that includes the functional nano-elements. The coating may be applied to the porous surface using any known method.

In some embodiments, the method may include reattaching new functional nano-elements to the surface of the product, every predetermined period of time during a service time of the product. In some embodiments, the product may be assembled in a system, for example, light transparent boards, formed according to any one of the embodiments disclosed above. The light transparent boards may be assembled in green-houses, may cover solar cells, or the like. Such boards may lose their auto-clean or hydrophobic nature in time (during service time) due to degradation in the amount of the functional nano-elements. A reattachment process may be performed directly on the product (e.g., the boards) as assembled, without the need to disassemble the product from the system. For example, the light transparent boards may be sprayed with an emulation including the functional nano-elements two years after being originally assembled, in order to regain the auto-clean property of the original board. In some embodiments, the reattaching process may be performed using any method disclosed above. In some embodiments, the reattaching process may be substantially identical to the first attaching process used to attach the functional nano-elements to the porous surface in the first place, or may be different. For example, the first attaching process may include spraying and UV radiating the sprayed surface and the reattaching process may include spraying with an emulation including an adhesive promoter.

Some aspects of the invention may be related to a product having an auto-clean (e.g., hydrophobic or super hydrophobic) surface such as the surface illustrated in FIG. 5. The product may include an open porosity on the surface (e.g., a porous surface) of the product, the open porosity may include pores having undercuts such as the undercuts shown in the products in process illustrated in FIGS. 1-3. The product may further include functional nano-elements attached to the surface, such that the functional nano-elements are located inside the open porosity as illustrated, for example, in FIG. 5.

The open porosity may be formed using any of the methods disclosed above and the functional nano-elements may be any functional nano-particle disclosed above. An exemplary open porosity may have a dimension D between 0.5 micron and 2 mm. In some embodiments, the distances between pores may be between 10-30 microns. In some embodiments, the functional nano-elements may be trapped inside the open porosity.

Some abrasive test results done to various products manufactured according to some embodiments of the invention are given in table 1, below.

The abrasion tests were performed according to ASTM D 968. ASTM D 968 measures the resistance of organic coatings to abrasion produced by abrasive falling onto coatings applied to a plane rigid surface, such as a metal or glass panel. The abrasive is allowed to fall from a specified height through a guide tube onto the coated panel. The contact and sliding angle were measured before and after the test. As can be seen, all the surfaces retained their auto-clean property having relatively high contact angle (around super hydrophobic angle) even after being treated with 50 gr. of sand. Therefore, it can be concluded that most of the function nano-elements attached to each surface, remained inside the open porosity of the surface and was not torn apart from the surface.

TABLE 1

| | Before | | After 25 gr sand | | After 30 gr sand | | After 40 gr sand | | After 50 gr sand | |
|---|---|---|---|---|---|---|---|---|---|---|
| | Con. | Sliding | Con. | Sliding | Con. | Sliding | Con. | Sliding | Con. | Sliding |
| | Angle | Angle | Angle | Angle | Angle | Angle | Angle | Angle | Angle | Angle |
| Foamed | 164 | 1 | 129.39 | 6.3 | 127.66 | 7.1 | 148.03 | <5 | 147.56 | <15 |
| PVC sheet + | | | | | | | | | | |
| Sanding + | | | | | | | | | | |
| Auto clean | | | | | | | | | | |
| solution | | | | | | | | | | |
| Chemically | 163.39 | 1 | 151.09 | 3.5 | 133.35 | 9.1 | 139.63 | <5 | 135.20 | 11.6 |
| etched PC + | | | | | | | | | | |
| Auto clean | | | | | | | | | | |
| solution | | | | | | | | | | |
| Foamed PC | 150.58 | 1 | 138.96 | 7.1 | 156.18 | 11.0 | 139.08 | <5 | 149.21 | 10.4 |
| sheet (small | | | | | | | | | | |
| bubbles) + | | | | | | | | | | |
| Sanding + | | | | | | | | | | |
| Auto clean | | | | | | | | | | |
| solution | | | | | | | | | | |
| Foamed PC | 157.80 | 1 | 144.51 | <15 | 141.00 | <15 | 148.58 | <15 | 146.90 | 26.9 |
| sheet (large | | | | | | | | | | |
| bubbles) + | | | | | | | | | | |
| Sanding + | | | | | | | | | | |
| Auto clean | | | | | | | | | | |
| solution | | | | | | | | | | |
| PC + Matt | 141.52 | 1 | 135.16 | <15 | 140.04 | <15 | 146.99 | <15 | 145.30 | >40 |
| agent in a | | | | | | | | | | |
| coating + | | | | | | | | | | |
| High power | | | | | | | | | | |
| 1 m/min + | | | | | | | | | | |
| Super | | | | | | | | | | |
| hydrophobic | | | | | | | | | | |
| solution | | | | | | | | | | |

In some embodiments, hydrophobic surfaces may be formed using a different method. These hydrophobic surfaces may not include functional nano-particles. Reference is now made to FIG. 7 which is a flowchart of a method of forming a super hydrophobic surface on a product. In box 710, embodiments may include printing a first layer on the surface of the product including a first material. The first layer may be printed using, for example, an ink jet printer. The first material may include any polymeric ink having a surface tension lower than 30 [Dyn/cm] and a wetting angle higher than 100°. Such a material when applied to a surface of a board may form rounded distinctive ink droplets on the surface.

In some embodiments, the first material may include Urethane acrylate based materials, Silicone-functional urethane acrylate, long alkyl chain acrylate, resins for E2C effect, leveling agents with fluoro or silicone groups, fluoro acrylates, fluoro based solvents, fluoro based silanes and/or the like.

Some embodiments may include printing the first layer at a first coverage percentage. The first layer may be printed such that some or all of the printed area is covered by the first material. In some embodiments, the inkjet printer printing head may include a plurality of nozzles each configured to fire a single droplet. In some embodiments, the inkjet printer may be configured to fire droplets with some or all of its firing nozzles. When the first coverage percentage is 100% coverage, all the nozzles included in the printing head will fire droplets at every position of the head over the printed surface. When the first coverage percentage is 50% coverage, half of the nozzles included in the printing head will fire droplets at every position of the head over the printed surface. In some embodiments, other methods may be used for having less than 100% coverage, for example, selectively firing droplets over the surface using a head having small (or single) number of nozzles, or the like.

Some embodiments may further include curing the printed first layer, for example, using Ultraviolet (UV) light or any other suitable curing method. The cured droplets may harden and stick to the surface of the board.

In box 720, some embodiments may include printing a second layer (e.g., by inkjet printing) over the first layer including a second material. The second material may include any polymeric ink having a surface tension lower than 30 [Dyn/cm] and a wetting angle higher than 100°. The second material may be the same or may be different from the first material. In some embodiments, the method may include printing the second layer at a second coverage percentage. The second coverage percentage may be different from the first coverage percentage of the first layer. For example, the first layer may be printed at 100% coverage and the second layer at 50% coverage, as illustrated in FIG. 8, discussed below.

In some embodiments, the method may include curing the second layer using any known curing method. In some embodiments, the method may further include printing a third layer on the second layer including a third material. The third materials may have a surface tension lower than 30 [Dyn/cm] and a wetting angle higher than 100°. In some embodiments, the method may include printing four or more layers from one of more materials having a surface tension lower than 30 [Dyn/cm] and a wetting angle higher than 100°. In some embodiments, all the printed layers may be printed from the same material. In some embodiments, each printed layer may be cured, using for example, UV curing. In some embodiments, each printed layer may have a corresponding printing coverage percentage.

Reference is made to FIG. 8 which is an illustration of a product 800 including a printed super hydrophilic surface according to some embodiments of the invention. Product 800 may include any synthetic board 805 that is configured or prepared to be printed with a polymeric printing. Product 800 may include a first printed layer 810 from a first printing material, printed at a first printing coverage. Printed layer 810 may include a plurality of droplets of the first material covering at least a portion of a surface 808 of board 805 at a first printing coverage, for example, the 100% coverage illustrated in FIG. 8.

Product 800 may further include a second printed layer 820 from a second printing material, printed at a second printing coverage (e.g., 50% coverage as illustrated). Layer 820 may be printed on top of layer 810, such that the droplets of layer 820 (that include the second material) are located above the droplets of layer 810. Both the first material and the second material may have a wetting angle higher than 100°.

In some embodiments, the first and second materials are the same material. In some embodiments, the first and second materials may include Urethane acrylate based materials, Silicone-functional urethane acrylate, long alkyl chain acrylate, resins for E2C effect, leveling agents with fluoro or silicone groups, fluoro acrylates, fluoro based solvents, fluoro based silanes and/or the like.

In some embodiments, product 800 may further include a thirds printed layer (not illustrated) from a third printing material, printed at a third printing coverage percentage. In some embodiments, product 800 may include four or more printed layers (not illustrated), each being printed at a corresponding printing coverage percentage, wherein each layer includes droplets of printed material having a wetting angle higher than 100°.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of forming a super hydrophobic surface on a product, comprising:
forming an open porosity on the surface of the product, the open porosity includes pores having undercuts; and
attaching functional nano-particles to the surface, such that the functional nano-particles are located inside the open porosity.

2. The method of claim 1, wherein the functional nano-particles are trapped inside the porosity.

3. The method of claim 1, wherein attaching the functional nano-particles comprises spraying an emulsion comprising the functional nano-particles on top of the surface.

4. The method of claim 1, wherein attaching the functional nano-particles comprises gluing the functional nano-particles to the surface.

5. The method of claim 1 or claim 2, wherein attaching the functional nano-particles comprises coating the surface with a coating that includes the functional nano-particles.

6. The method according to claim 1, wherein forming the open porosity comprises:
mixing a blowing agent in a polymeric mixture;
extruding the polymeric mixture and the blowing agent to form the product; and
etching the surface of the product to form the open porosity that includes pores having undercuts.

7. The method according to claim 1, wherein forming the open porosity comprises:
extruding a base product from a first polymeric mixture;
mixing a blowing agent in a second polymeric mixture;
co-extruding an additional layer comprising the second polymeric mixture and the blowing agent on the base product to form the product; and
etching the surface of the product to form the open porosity that includes pores having undercuts.

8. The method according to claim 1, wherein forming the open porosity comprises:
etching the surface of the product with a porosity forming etching solution.

9. The method according to claim 1, wherein forming the open porosity comprises:
printing a first layer on the surface of the product comprising a first material; and
printing a second layer on the first layer comprising a second material,
wherein the first and second materials has a surface tension lower than 30 [Dyn/cm] and a wetting angle higher than 100°.

10. The method of claim 9, further comprising printing four or more layers from one of more materials having a surface tension lower than 30 [Dyn/cm] and a wetting angle higher than 100°.

11. The method of claim 9, wherein the first layer is printed at a first coverage percentage and the second layer is printed at a second coverage percentage.

12. The method according to claim 1, further comprising:
reattaching new functional nano-particles to the surface, every predetermined period of time during a service time of the product.

13. A product having a super hydrophobic surface comprising:
an open porosity on the surface of the product, the open porosity includes pores having undercuts; and
functional nano-particles attached to the surface, such that the functional nano-particles are located inside the open porosity.

14. The product of claim 13, wherein the functional nano-particles are trapped inside the open porosity.

15. A method of forming a super hydrophobic surface on a product, comprising:
printing a first layer on the surface of the product comprising a first material; and
printing a second layer on the first layer comprising a second material,
wherein the first and second materials has a surface tension lower than 30 [Dyn/cm] and a wetting angle higher than 100°.

16. The method of claim 15, further comprising:
printing a third layer on the second layer comprising a third material,
wherein the third materials has a surface tension lower than 30 [Dyn/cm] and a wetting angle higher than 100°.

17. The method of claim 15, further comprising printing four or more layers from one of more materials having a surface tension lower than 30 [Dyn/cm] and a wetting angle higher than 100°.

18. The method according to claim 15, wherein all the printed materials are the same.

19. The method according to claim 15, further comprising:
curing each printed layer.

20. The method according to claim 15, wherein the first layer is printed at a first coverage percentage and the second layer is printed at a second coverage percentage.
